(19) United States
(12) Patent Application Publication
(10) Pub. No.: US 2013/0073469 A1
(43) Pub. Date: Mar. 21, 2013

(54) COORDINATING EXECUTION OF A COLLABORATIVE BUSINESS PROCESS

(71) Applicants: Theo Dirk Meijler, Dresden (DE); Zbigniew Jerzak, Dresden (DE)

(72) Inventors: Theo Dirk Meijler, Dresden (DE); Zbigniew Jerzak, Dresden (DE)

(21) Appl. No.: 13/235,627

(22) Filed: Sep. 19, 2011

(51) Int. Cl. G06Q 10/00

(52) U.S. Cl. 705/301

(57) ABSTRACT

Various embodiments of systems and methods for coordinating execution of a collaborative business process are described herein. An internal process included in a parent collaborative business process is executed to receive a process plan for the collaborative business process. Based on the received process plan, business entity types are instantiated to create child collaborative business entities. The execution of the created child collaboration business entities is coordinated to execute the collaborative business process. The business entity types include predefined internal process which is executed during the execution of the child collaborative business entities. In one embodiment, the parent collaborative business entity synchronizes the execution of the child collaborative business entities.

### FIELD

Embodiments generally relate to computer systems, and more particularly to methods and systems for a collaborative business process.

### BACKGROUND

In supply chains, various organizations collaborate with each other, both in production as well as in logistics or in a combination of both. Moreover supply chain requires agility. In logistics for example, the logistics service provider and (other) logistics partners must be able to flexibly react to changing circumstances to handle issues during transport.

Current technologies for inter-organizational collaboration systems are situated in the area of work flow management. However, these technologies are not suited for the purpose of supply chains, due to several reasons. For example, workflow technologies are mainly used for coordination and not for sharing data, which leads to a lack of visibility in the supply chain. Further, workflow technologies do not support flexibility as required in logistics. For example, these technologies do not allow a user to plan a collaborative business process, such as transport, at run-time, i.e., during the execution of the collaborative business process. Also, these technologies expect business users to completely define the collaboration process schema for the collaborative process. This requires a business user to have complete knowledge of all the processes required for executing the collaborative business process, which may be undesirable.

### SUMMARY

Various embodiments of systems and methods for coordinating execution of a collaborative business process are described herein.

In one aspect, an internal process stage included in a parent collaborative business entity is executed on a collaboration hub to receive a process plan for the collaborative business process.

In another aspect, based on the process plan, the collaboration hub instantiates a business entity type to create one or more child collaborative business entity.

In yet another aspect, the execution of the created one or more child collaborative business entities is coordinated to execute the collaborative business process.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating a collaborative business entity for a collaborative business process, according to an embodiment.

FIG. 2 is a flow diagram illustrating a method for coordinating execution of the collaborative business process, according to an embodiment.

FIG. 3 is a block diagram illustrating a business entity type, according to an embodiment.

FIG. 4 is a block diagram illustrating a collaborative business entity created by instantiating the business entity type of FIG. 3, according to an embodiment.

FIG. 5 is a block diagram illustrating synchronization of a child collaborative business entity 1 and a child collaborative business entity 2, according to an embodiment.

FIG. 6 is a block diagram illustrating execution of parent collaborative business entity, according to an embodiment.

FIG. 7 is a block diagram illustrating a collaboration hub, according to an embodiment.

FIG. 8 is a block diagram illustrating an exemplary collaboration in a supply chain, according to an embodiment.

FIG. 9 is a block diagram illustrating a “transport” parent collaborative business entity which is executed for coordinating the “transport” collaborative business process of FIG. 8, according to an embodiment.

FIG. 10 is a block diagram illustrating a process plan for the “transport” collaborative business process, according to an embodiment.

FIG. 11 is a block diagram illustrating a “transport leg” business entity type, according to an embodiment.

FIG. 12 is a block diagram illustrating a “transport leg 1” child collaborative business entity created by instantiating the “transport leg” business entity type of FIG. 11, according to an embodiment.

FIG. 13 is a block diagram illustrating synchronization between a “transport” parent collaborative business entity, and the “transport leg 1” child collaborative business entity 1 and a “transport leg 2” child collaborative business entity, according to an embodiment.

FIG. 14 is a block diagram illustrating a screenshot of a portal for the “transport leg 1” child collaborative business entity of FIG. 12, according to an embodiment.

FIG. 15 is a block diagram illustrating a computing environment in which the techniques described for coordinating the collaborative business process can be implemented, according to an embodiment.

### DETAILED DESCRIPTION

Embodiments of techniques for coordinating execution of a collaborative business process are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

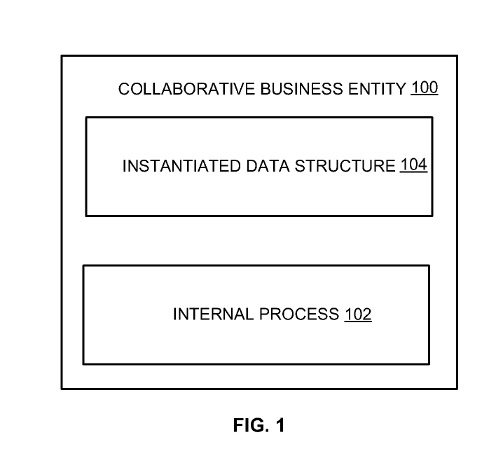

FIG. 1 is a block diagram illustrating a collaborative business entity 100 for a collaborative business process, according to an embodiment. A collaborative business process is a process which requires business partners or business partner systems to work together in collaboration for pursuing common business goals. A business partner may be any person who is directly or indirectly related to the collaborative business process. An example of a collaborative business process may be “transport” between two cities A and B, which may require collaboration between at least three business partners, a seller (business partner 1) who wants goods to be transported from city A to city B, a transporter (business partner 2) who transports the goods from city A to city B, and a buyer (business partner 3) who receives the goods at city B.

The collaborative business entity 100 is used to realize the collaborative business process. The collaborative business entity 100 includes an internal process 102 which is executed for coordinating the execution of the collaborative business process. The internal process 102 is predefined depending on the process required for executing the collaborative business process. Different internal processes are required for different collaborative business process. For example, the “transport” collaborative business process requires an internal process for coordinating the “transport”. The internal process of the “transport” collaborative business process may include: sending an invitation to a business partner for handling the “transport”, creating a process plan for the “transport”, “monitoring the execution of different legs”, etc. A “transport” collaborative business entity is used to coordinate and share data about the “transport” collaborative business process that includes the internal process for coordinating the “transport”. The collaborative business entity 100 also includes an instantiated data structure 104, which stores execution related data for the collaborative business process allowing partner to share data about the process. For example, the instantiated data structure for the “transport” collaborative business process stores the origin of the transport (city A), and the destination of the transport (city B).

The collaborative business entity 100 may be a parent collaborative business entity for coordinating and data sharing the collaborative business process or a child collaborative business entity for coordinating and data sharing a portion of the collaborative business process. In the above example, the “transport” collaborative business entity is the parent collaborative business entity that coordinates the “transport” collaborative business process from city A to city B.

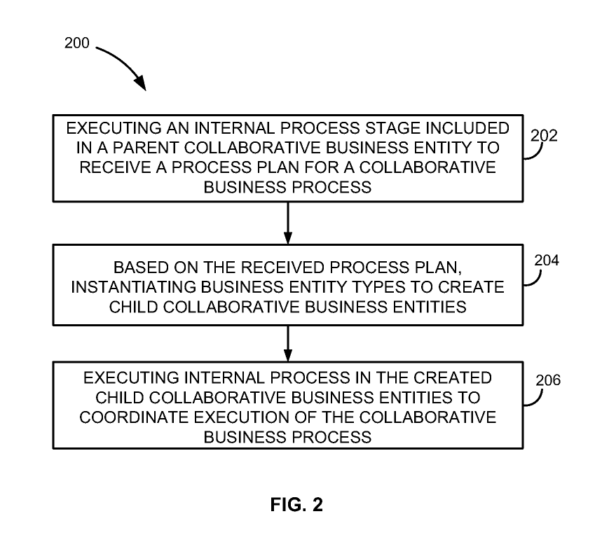

FIG. 2 is a flow diagram 200 illustrating a method for coordinating execution of the collaborative business process, according to an embodiment. In one embodiment, the internal process of the child collaborative business entities are executed for coordinating execution of the collaborative business process.

As shown in FIG. 2, initially the collaboration hub executes an internal process stage included in the parent collaborative business entity to request for and receive as a response a process plan for the collaborative business process (block 202). The internal process of the collaborative business entity includes internal process stages which are executed for coordinating execution of the collaborative business process. When one of the internal process stages included in the parent collaborative business entity is executed the process plan for the collaborative business process is received. The received process plan includes execution related data for executing the collaborative business process. For example, a process plan for the “transport” collaborative business process from city A to city B may includes details of two “transport legs” that makes up the “transport” from city A to city B, a “transport leg 1” from city A to city C, and a “transport leg 2” from city C to city B, for executing the “transport” collaborative business.

Next, based on the process plan received at block 202, the collaboration hub instantiates business entity types to create child collaborative business entities (block 204). A business entity type includes the predefined internal process and a data structure which is instantiated to create the child collaborative business entity. The process plan received at block 202 is used for instantiating the business entity types to create the child collaborative business entities. In the above example, the collaboration hub instantiates a “transport leg” business entity type, to create: a “transport leg 1” child collaborative business entity for the “transport leg 1” from city A to city C, and a “transport leg 2” child collaborative business entity for the “transport leg 2” from city C to city B.

Finally, at block 206, the internal process included in the child collaborative business entities created at block 204 are executed in order to coordinate the execution of the collaborative business process. In the above example, the internal process included in the “transport leg 1” child collaborative business entity and the “transport leg 2” child collaborative business entity are executed for coordinating execution of the “transport” collaborative business process.

Further, the parent collaborative business entity synchronizes the child collaborative business entities created at block 204. In the above example, the “transport” collaborative business entity (parent) synchronizes the execution of “transport leg 1” child collaborative business entity and the “transport leg 2” child collaborative business entity for example by enabling the execution of the process stage for handling the start of transport leg 2 only if the process stage for handling the arrival of transport leg 1 has finished execution.

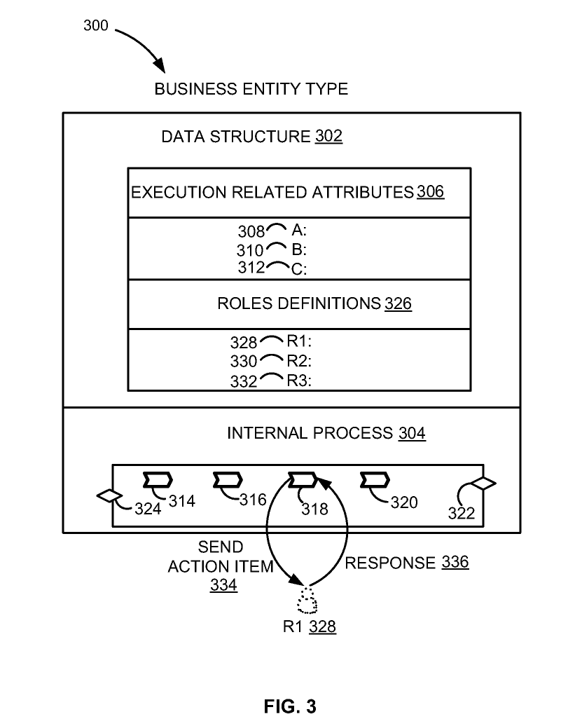

FIG. 3 is a block diagram illustrating a business entity type 300, according to an embodiment. The business entity type 300 is defined for collaborative business process of a particular type. For example, a “transport” business entity type is defined for collaborative business process of type “transport”. The business entity type 300 includes a data structure 302 and an internal process 304. The data structure 302 defines run-time relevant data for the collaborative business process of the particular type. For example, the data structure for the “transport” business entity type includes runtime relevant data required for “transport” such as “origin” of the transport, “destination” of the transport, “planned start time” of the transport, “planned arrival time” of the transport, etc. The data structure 302 includes execution related attributes 306, which defines the runtime relevant data for the collaborative business process. The execution related attributes 306 include an execution related attribute A 308, an execution related attribute B 310, and an execution related attribute C 312.

The internal process 304 included in the business entity type defines the internal process for the collaborative business process of the particular type. For example, a “deal” business entity type includes the internal process of a “deal” collaborative business process (collaborative business process of type “deal”). The internal process of the “deal” business entity may include: creating a contract, creating a letter of credit, etc. The internal process 304 includes internal process stages 314, 316, 318, and 320, which are to be executed for executing the internal process 304. For example, the internal process included in the “deal” business entity type includes: a “contract” internal process stage for creating the contract, a “letter of credit” internal process stage for creating the letter of credit, etc. As discussed above, the parent collaborative business entity synchronizes the execution of the child collaboration business entities. The business entity type includes synchronization points 322 and 324, which defines the synchronization between two different business entity types.

The business entity type 300 may be defined at design time by a developer. The developer defines the data structure 302 and the internal process 304 for defining the business entity type 300. The developer may design the business entity type 300 based on their knowledge of the process and the run-time data required for executing the collaborative business process. For example, a developer may based on their knowledge of the “transport” collaborative business process define the internal process for a “transport” business entity type to include: an internal process stage for receiving the process plan for “transport”, an internal process stage for creating the “transport legs” for the “transport”, coordinating the transport legs, etc. The developer also develops the data structure for the “transport” collaborative business entity, which includes execution related attributes for “transport” such as origin, destination, planned start time, etc.

In one embodiment, the business entity type 300 is defined using a Guard-Stage-Milestone (GSM) model. The main element of the GSM model is a stage which is built on three main constructs: 1) a milestone which represents the business relevant objective of the stage, 2) a stage body containing one or more activities, such as a service call, intended to achieve the milestone, and 3) a guard, which is a condition and possibly a triggering event that when achieved, enables entry into the stage body. In principle, any other data and process definition language, for example BPMN or STG in combination with UML, can also be used for defining the business entity type 300. After defining the data structure 302 and the internal process 304 the business entity type 300 is stored in the collaboration hub. The stored business entity type 300 can then be used to create instances of the business entity type 300.

The data structure 302 also includes role definitions 326. Role definitions 326 define various roles that business partners have to play during the execution of the collaborative business process. The role definitions 326 of the business entity type 300 have a role definition R1 328, a role definition R2 330, and a role definition R3 332. The internal process 304 defines an association between the internal process stages 314, 316, 318, and 320 and the role definitions R1 328, R2 330, and R3 332. As shown in FIG. 3 the internal process stage 318 is associated to the role definition R1 328. When the internal process stage 318 is executed an action item 334 is sent to a business partner bound to the role R1 328. The business partner bound to the role R1 328 sends a response 336 after receiving the action item 334.

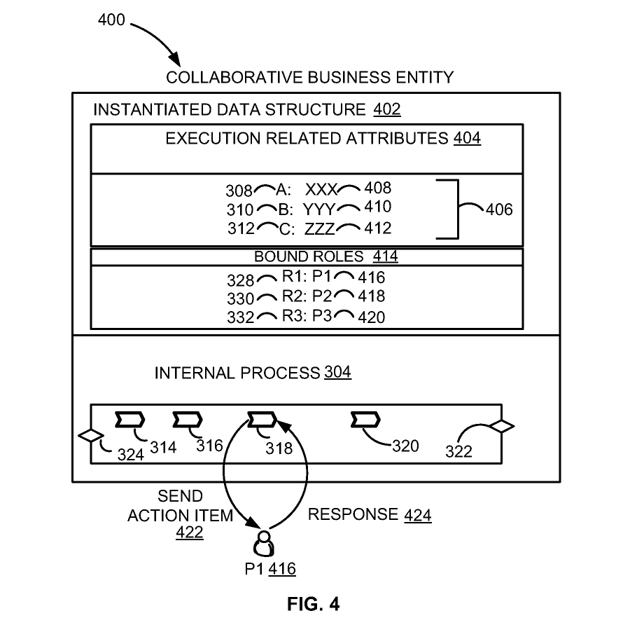

FIG. 4 is a block diagram illustrating a collaborative business entity 400 created by instantiating the business entity type 300 of FIG. 3, according to an embodiment. The collaborative business entity 400 may be a parent collaborative business entity or a child collaborative business entity. The collaborative business entity 400 is created by instantiating the data structure 302 of the business entity type 300 (FIG. 3). As shown, the collaborative business entity 400 includes an instantiated data structure 402 which is an instance of the data structure 302 of the business entity type 300 (FIG. 3). The instantiated data structure 402 includes execution related attributes 404 which is created by initializing the execution related attributes 306 of the business entity type 300 (FIG. 3) with execution related data 406. The execution related data 406 may include an execution related data “XXX” 408, an execution related data “YYY” 410, and an execution related data “ZZZ” 412. The execution related attributes 404 include the execution related attributes A 308, B 310, and C 312 of the business entity type 300 (FIG. 3) initialized with the execution related data XXX 408, YYY 410, and ZZZ 412, respectively. The execution related data 406 is stored in the created collaborative business entity 400. In the above example, the execution related attributes “origin” of the transport and “destination” of the “transport” included in the “transport” business entity type is initialized with execution related data “city A” and “city B”, respectively to create the “transport” collaborative business entity.

In case the collaborative business entity 400 is the child collaborative business entity, the execution related data 406 is received in the process plan for the collaborative business process. The process plan may also provide that the business entity type 300 of FIG. 3 is to be instantiated for creating the collaborative business entity 400. In the above example, the process plan may state that a “transport leg” collaborative business entity type is to be instantiated for creating the “transport leg 1” and the “transport leg 2” child collaborative business entities. As discussed above, the collaboration hub stores the business entity type 300 (FIG. 3). Based on the process plan of the collaborative business process, the business entity type 300 stored in the collaboration hub is instantiated to create the collaborative business entity 400.

The instantiated data structure 402 also includes bound roles 414 created by binding the role definitions 326. The role definition R1 328, R2 330, and R3 332 of the business entity type 300 of FIG. 3 are bound with business partner P1 416, business partner P2 418, and business partner P3 420, respectively. The business partners P1 416, P2 418, and P3 420 thus take up the role R1 328, R2 330, and R3 330, respectively. In one embodiment, the binding of the partners is done as a part of the collaborative business process, using a “Role Fulfillment” collaborative business entity.

Further, the collaborative business entity 400 also includes the internal process 304 of the business entity type 300 of FIG. 3. The internal process stages 314, 316, 318, and 320 included in the internal process 304 are executed for executing the collaborative business entity 400. Based on the association between the internal process stages 314, 316, 318, and 320 and the roles R1 328, R2 330 and R3 332 as defined in the business entity type 300 of FIG. 3, the internal process 304 binds the business partners P1 416, P2 418, and P3 420 to the internal process stages 314, 316, 318, and 320, respectively. As discussed above in FIG. 3, the internal process stage 318 is associated with the role definition R1 328. Therefore, the business partner P1 (bound to the role R1) is bound to the internal process stage 318. The internal process stages 314, 316, 318, and 320 are executed for coordinating execution of the collaborative business entity 400. In one embodiment, when the internal process stage 318 is executed an action item 422 is sent to the business partner P1 416. Based on the received action item 422, the business partner P1 416 sends a response 424 to the collaboration hub. The collaborative business entity 400 may store the received response 424 as a collaborative business entity status by updating the instantiated data structure 402, and/or by changing the status of the internal process 304. The action item 422 may be a query relating to the collaborative business process or a request to confirm whether the objective of the internal process stage 318 has been achieved. Based on the received response 424, another internal process stage 320 is executed.

In the above example, the “transport leg 1” child collaborative business entity may include an internal process stage, which when executed sends an action item to a business partner handling the execution of the “transport leg 1”. The action item may be an enquiry whether the execution of the “transport leg 1” has started. After receiving the action item the user's system may send a response “execution started” to the collaboration hub. The response “execution started” is stored as the status of the “transport leg 1” in the “transport leg 1” collaborative business entity. Based on the response, another internal process stage of the “transport leg 1” child collaborative business entity is executed to enquire whether the goods have arrived at city C.

The business entity type 300 of FIG. 3 and the collaborative business entity 400 can be considered analogous to a class and class objects, respectively, in object oriented programming. The business entity type, defined for a collaborative business process of a particular type, can be used to create collaborative business entities for different collaborative business process of same type. Consider a “transport 1” collaborative business process for a transport from city D to city E, and a “transport 2” collaborative business process for a transport from city X to city Y. A “transport 1” collaborative business entity and a “transport 2” transport collaborative business entity are created for the “transport 1” collaborative business process and the “transport 2” collaborative business process, respectively, by instantiating a “transport” business entity type. As the type, i.e., “transport”, for the collaborative business process (“transport 1” and “transport 2”) is same the corresponding collaborative business entities (“transport 1” collaborative business entity and the “transport 2” collaborative business entity) are created using the same “transport” business entity type. The internal process for the “transport” business entity type is included in the “transport 1” collaborative business process and the “transport 2” collaborative business process. The data structure of the “transport” business entity type is initialized with the execution related data (city D and city E) of “transport 1” for “transport 1” collaborative business entity and the execution related data (city X and city Y) of “transport 2” for “transport 2” collaborative business entity.

In one embodiment, the collaborative business entity 400 is executed by a “viral” collaboration between different business partners. The “viral” collaboration may be supported by a “Role Fulfillment” collaborative business entity. The “viral” collaboration includes a business partner inviting another business partner during the execution of the collaborative business process. In the example for the “transport” from city A to city B, the seller invites an organizer to plan the transport from city A to city B, the transporter can then invite a carrier 1 and a carrier 2 for executing the “transport leg 1” and the “transport leg 2”, respectively.

The synchronization points 322 and 324 defined in the business entity type 300 (FIG. 3) are used for synchronizing the created collaborative business entity 400. The synchronization points may be defined to synchronize the child collaborative business entities, during execution of the collaborative business process.

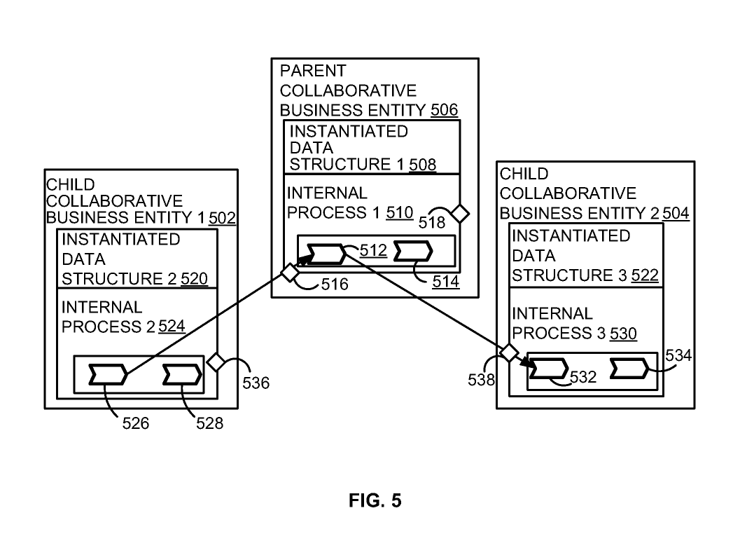

FIG. 5 is a block diagram illustrating synchronization of a child collaborative business entity 1 502 and a child collaborative business entity 2 504, according to an embodiment. A parent collaborative business entity 506 is coordinating a collaborative business process. As discussed above, a process plan is received for the collaborative business process. Based on the process plan, the child collaborative business entity 1 502 and the child collaborative business entity 2 504 are created. The parent collaborative business entity 506 includes the instantiated data structure 1 508 and the internal process 1 510. The internal process 1 510 includes internal process stages 512 and 514 which are to be executed for executing the parent collaborative business entity 506. The parent collaborative business entity 506 includes pre-defined synchronization points 516 and 518.

The child collaborative business entity 1 502 and the child collaborative business entity 2 504 include the instantiated data structure 2 520 and the instantiated data structure 3 522, respectively. The child collaborative business entity 1 502 includes an internal process 2 524 which is to be executed for executing the child collaborative business entity2 502. The internal process 2 524 includes internal process stages 526 and 528. The child collaborative business entity 2 504 includes an internal process 3 530 which is executed for executing the child collaborative business entity 2 504. The internal process 3 530 includes internal process stages 532 and 534. The child collaborative business entity 1 502 includes a synchronization point 536. The child collaborative business entity 2 504 includes a synchronization point 538.

The parent collaborative business entity 506 synchronizes the child collaborative business entity 1 502 and the child collaborative business entity 2 504 by synchronizing the internal process stages 526 and 528 of the child collaborative business entity 1 502 with the internal process stages 532 and 534 of the child collaborative business entity 2 504. For example, the parent collaborative business entity 506 may synchronize the internal process stage 526 and 532 of the child collaborative business entity 1 502 and the child collaborative business entity 2 504, respectively. In this case, the parent collaborative business entity 506, using synchronization point 516, waits in its stage 512 for receiving a message from the child collaborative business entity 1 502 that the internal process stage 526 is over. After receiving the message from the internal process 2 526, the internal process stage 512 of the parent collaborative business entity 506 uses synchronization point 538 of the child collaborative business entity 504, to send a message to the internal process stage 532 of the child collaborative business entity 2 504 to start execution. The synchronization points 516 and 538 basically represents messages expected by the internal process stage 512 and the internal process stage 532, respectively. In FIG. 5, for sake of simplicity synchronization between only two child collaborative business entities 502 and 504 has been shown. However, any number of child collaborative business entities can similarly be synchronized using synchronization points between the parent and the child collaborative business entities.

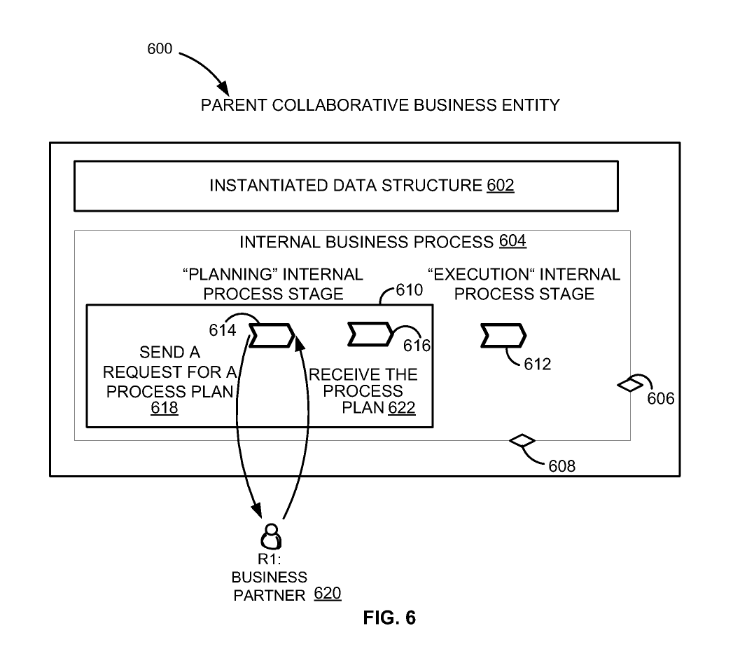

FIG. 6 is a block diagram illustrating execution of a parent collaborative business entity 600, according to an embodiment. As shown, the parent collaborative business entity 600 includes the instantiated data structure 602 and the internal process 604. The parent collaborative business entity 600 also includes synchronization points 606 and 608. In one embodiment, the internal process 604 of the parent collaborative business entity 600 includes a “planning” internal process stage 610, and an “execution” internal process stage 612.

As discussed above, the parent collaborative business entity 600 coordinates the execution of the collaborative business process. During execution of the parent collaborative business entity 600, initially the “planning” internal process stage 610 is executed. The “planning” internal business stage 610 includes a “planning” sub-stage 1 614 and a “planning” sub-stage 2 616. When the “planning” sub-stage 1 614 is executed, an action item 618 is sent to a business partner 620 for creating the process plan for the collaborative business process. As shown, the business partner 620 is playing a role R1 defined in the business entity type of the parent collaborative business entity 600. After receiving the action item 618, the business partner 620 creates the process plan for the collaborative business process and sends a response 622, which is the created process plan, to the collaboration hub. The process plan may include execution related data for creating the child collaborative business entities. After receiving the process plan, the collaboration hub executes the “planning” sub-stage 2 616 to create the child collaborative business entities, based on the process plan. Thus, the business partner 620 can plan the collaborative business process during the execution of the parent collaborative business entity 600, i.e., at runtime.

Finally, after the child collaborative business entities for the collaborative business process are created, the “execution” internal process stage 612 is executed. When the “execution” internal process stage 612 is executed the execution of the child collaborative business entities (created after executing the “planning” sub-stage 2 616) is started. The “execution” internal process stage 612 is executed to coordinate all the child collaborative business entities that were created after executing the “planning” sub-stage 2 616.

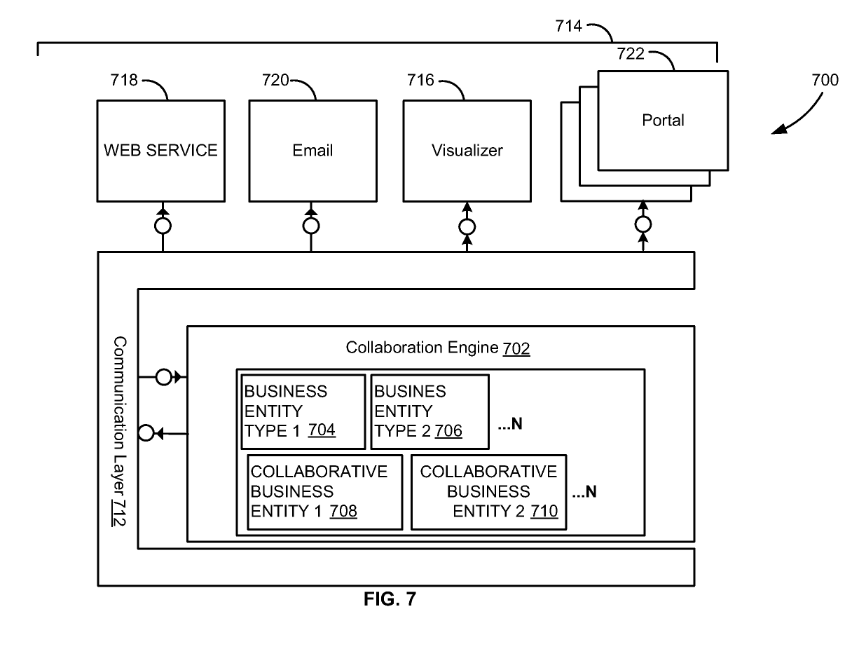

FIG. 7 is a block diagram illustrating a collaboration hub 700, according to an embodiment. The collaboration hub 700 includes a collaboration engine 702 that stores a business entity type 1 704, a business entity type 2 706, a collaborative business entity 1 708, and a collaborative business entity 2 710. The collaborative business entity 1 708 and the collaborative business entity 2 710 may be a parent collaborative business entity or a child collaborative business entity. A person ordinarily skilled in the art can understand that any number of business entity types and collaborative business entities may be stored in the collaboration engine 702.

The collaboration engine 702 creates instance of the business entity type 1 704 or business entity type 2 706, based on the process plan for the collaborative business process. Further in case the collaborative business entity 1 708 and the collaborative business entity 2 710 are child collaborative business entities the “parent” collaborative business entity coordinates execution of the internal process of the child collaborative business entity 1 708 and the child collaborative business entity 2 710 through the synchronization points for executing the collaborative business process.

The collaboration hub 400 also includes a communication layer 712 and a set of external components 714 which are used to interface with the collaboration engine 700. The collaboration engine 702 provides the collaborative business entity status of the collaborative business entity 1 708 and the collaborative business entity 2 710 to the external components. The external components 714 may include a “visualizer” 716 which is used to visualize status of the collaborative business process. The external components may also include a “web service” 718. In one embodiment, the “web service” 718 can be used for automatic creation of process plan for the collaborative business process. Further, the external components 714 can also include an “E-Mail” 720 or a web portal “Portal” 722 which can be used for interactive communication with business partners. For example, an E-mail invitation may be sent to a new business partner to take part in collaboration.

Further, whenever there is a change in the status of the collaborative business entity 1 708 or the collaborative business entity 2 710 a change event is sent to the business partners via the “portal” 722. In one embodiment, the notification includes the collaborative business entity status of the collaborative business entity 1 708 or the collaborative business entity 2 710. In another embodiment, the notification only provides an indication of a change and does not include the collaborative business entity status of the collaborative business entity 1 708 or the collaborative business entity 2 710. In this case, the business partner can login to the portal 722 and download the collaborative business entity status of the collaborative business entity 1 708 or the collaborative business entity 2 710 from the portal 722.

The communication layer 712 routes an action item or an event corresponding to the collaborative business entity 1 708 or the collaborative business entity 2 710 from the collaboration engine 702 to the external components 714. A business partner receiving the action item from the external components 714 can respond to the action item via the external components 714. The communication layer 712 also allows the external components 714 to subscribe to new events, such as change to the collaborative business entity status of the collaborative business entity 1 708 or the collaborative business entity 2 710.

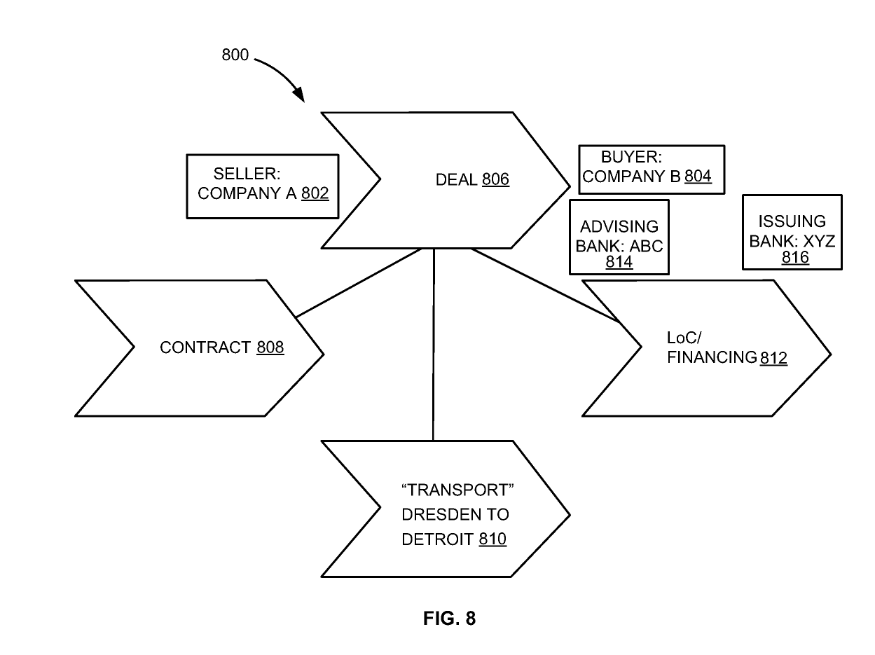

FIG. 8 is a block diagram illustrating an exemplary collaboration 800 in a supply chain, according to an embodiment. Consider the following exemplary scenario, a “company A” 802 produces cars of “type A” in Dresden. A “company B” 804 wants to buy three cars of “type A” from “company A” 802 and sell it in Detroit. The collaboration 800 is to be executed for executing the sale of the three cars of “type A” from “company A” 802 to “company B” 804. As shown, the collaboration 800 includes: a “deal” collaborative business process 806, a “contract” collaborative business process 808, a “transport” collaborative business process 810, and a “financing” collaborative business process 812.

In the “deal” collaborative business process 806 a deal is set between the seller: “company A” 802 and the buyer: “company B” 804 for the sale of three cars of “type A”. The “contract” collaborative business process 808 includes setting a contract between the “company A” 802 and the “company B” 804 for the sale of three cars of “type A”. In the “financing” collaborative business process 812 a Letter of Credit (LoC) is created in which an advising bank: ABC 814 and an issuing bank: XYZ 816 are involved. The issuing bank: XYZ 816 issues the letter of credit for the purchase by company B of three cars of type “A”. Finally, the “transport” collaborative business process 810 is for transport of the three cars of “type A” from Dresden to Detroit. The “company A” 802 takes care of the transport of the three cars of “type A” from Dresden to Detroit.

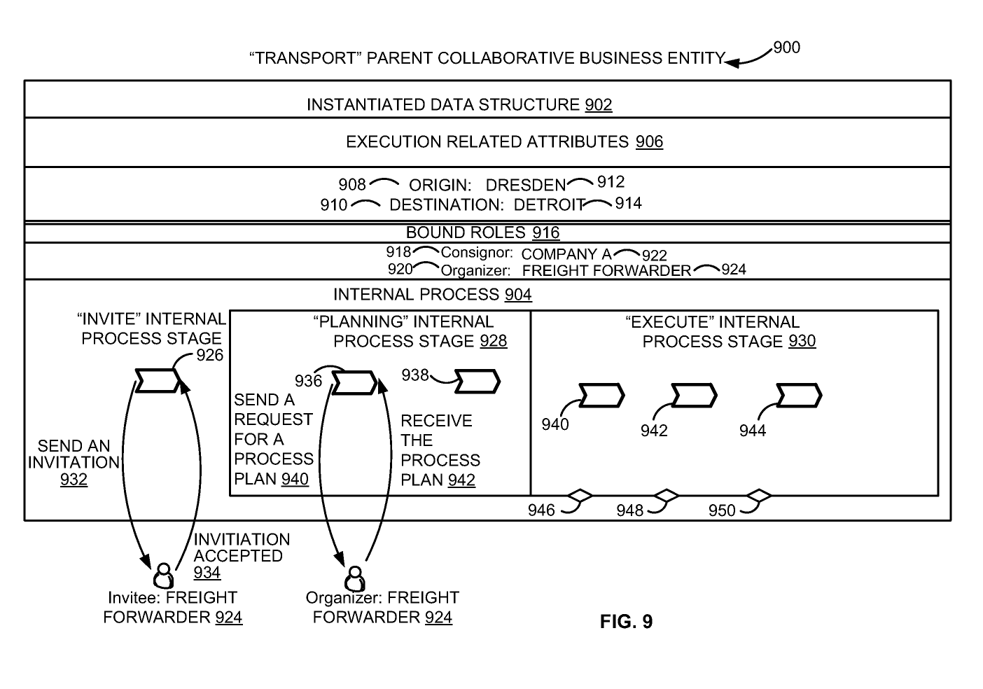

FIG. 9 is a block diagram illustrating a “transport” parent collaborative business entity 900 which is executed for coordinating the “transport” collaborative business process 810 of FIG. 8, according to an embodiment. The “transport” collaborative business entity 900 includes an instantiated data structure 902 and an internal process 904. The instantiated data structure 902 includes execution related attributes 906 which includes: “origin” 908 and “destination” 910. The execution related attribute “origin” 908 is initialized with the execution related data “DRESDEN” 912 which is the origin of the “transport” collaborative business process. The execution related attribute “destination” 910 is initialized with the execution related data “DETROIT” 914 which is the destination of the “transport” collaborative business process, respectively. The instantiated data structure 902 also includes bound roles 916 which has role definition “Consignor” 918 and role definition “Organizer” 920 bound with “Company A” 922 and freight forwarder 924, respectively.

The internal process 904 is executed for executing the “transport” parent collaborative business entity 900. The internal process includes an “invite” internal process stage 926, a “planning” internal process stage 928, and an “execute” internal process stage 930.

During execution of the “transport” parent collaborative business entity 900, initially the “invite” internal process stage 926 is executed. As shown, when the “invite” internal process stage 926 is executed the “Company A” 922 sends an invitation 932 to the freight forwarder 924 for organizing the “transport” collaborative business process, i.e., overtaking the “Organizer” role, and thus organizing the transport of the three cars of “type A” from Dresden to Detroit. The freight forwarder 924 can accept or reject the invitation. In case the freight forwarder 924 accepts the invitation a message “invitation accepted” 934 is sent to the collaboration hub. In one embodiment, a “Role Fulfillment” collaborative business entity is executed for inviting the “freight forwarder” 924. In a “Role Fulfillment” collaborative business entity two business partner roles are defined: an inviter, who is the business partner that invites another partner, and an invitee. The “Role Fulfillment” business entity refers back to the “transport” parent collaborative business entity, the invitee in the “Role Fulfillment” overtakes the responsibility of the “transport” collaborative business process, and is thus bound to the role “Organizer”. In the example, the inviter is the “Company A” 922 and the invitee is the “freight forwarder” 924, who takes up the organizing role, and becomes responsible for handling the “transport” collaborative business process.

After the freight forwarder 924 accepts the invitation, the “planning” internal process stage 928 is executed. The “planning” internal process stage 928 includes a sub-stage 1 936 and a sub-stage 2 938. When the “planning” internal process stage 928 is executed, initially the sub stage 1 936 is executed to send an action item 940 to the freight forwarder 924 for preparing a process plan for the “transport” collaborative business process. After receiving the action item 940, the freight forwarder 924 prepares the process plan and sends as a response 942 the process plan for the “transport” collaborative business process. The process plan includes information about the “transport legs”, which are to be executed for executing the “transport” collaborative business process from Dresden to Detroit. The information may include the origin and destination of each of these “transport legs”, the business entity type to be instantiated for creating these transport legs, etc. The process plan for the “transport” collaborative business entity is received at the collaboration hub.

After the process plan from the freight forwarder 924 is received, the sub stage 2 938 of the “planning” internal process stage 928 is executed. When the “sub stage 2” 938 is executed the collaboration hub creates the “transport leg” child collaborative business entities based on the process plan received at sub stage 1 936. Such child “transport leg” collaborative business entities have their own internal process that is principally independently executed, however in synchronization with the “transport” parent collaborative business entity 900.

After the “transport leg” child collaborative business entities have been created at sub stage 2 938 of the “transport” collaborative business entity the “execute” internal process stage 930 is executed. The “execute” internal process stage 930 includes “reserve” internal process sub-stage 1 940, “start” internal process sub-stage 2 942, and “monitor” internal process sub-stage 944. The “execute” internal process stage 930 takes care of the synchronization with the internal processes of the “transport leg” child collaboration business entities, using synchronization points 946, 948 and 950.

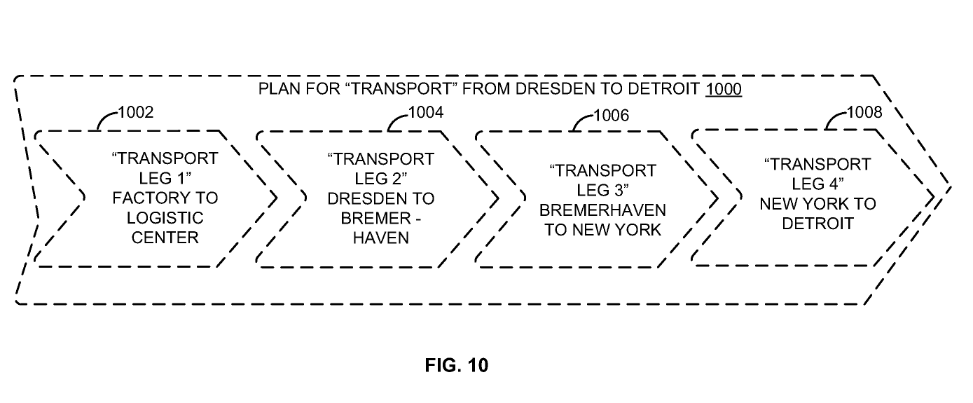

FIG. 10 is a block diagram illustrating a process plan 1000 for the “transport” collaborative business process 810 of FIG. 8, according to an embodiment. As shown in the process plan 1000, the freight forwarder has planned the execution of the “transport” collaborative business process 810 in four “transport legs” 1002, 1004, 1006, and 1008. In the “transport leg 1” 1002 the three cars of “type A” is to be moved by a tram from the “factory” in Dresden to a “logistic center” in Dresden. In the “transport leg 2” 1004, the three cars of “type A” are to be transported from the “logistic center” in Dresden to Bremerhaven by a train. Next in “transport leg 3” 1006, the three cars of “type A” are to be transported from Bremerhaven to New York by ship, which is the carrier for the “transport leg 3” 1006. Finally in “transport leg 4” 1008 the three cars of “type A” are transported from New York to Detroit by truck. The process plan 1000 may also provide that a “transport leg” business entity type is to be instantiated for creating the “transport leg” child collaborative business entities corresponding to the planned legs “transport leg 1” 1002, “transport leg2” 1004, “transport leg 3” 1006, and “transport leg 4” 1008.

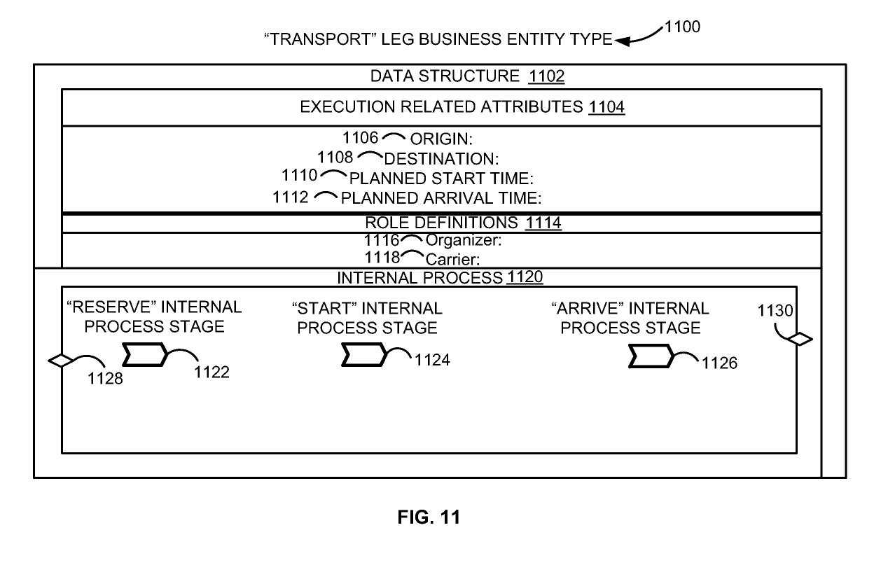

FIG. 11 is a block diagram illustrating a “transport leg” business entity type 1100, according to an embodiment. The “transport leg” business entity type 1100 includes a data structure 1102 which includes execution related attributes 1104. The execution related attributes 1104 include “origin” 1106 of the transport leg, “destination” 1108 of the transport leg, “planned start time” 1110 of the transport leg, and a “planned arrival time” 1112 of the transport leg. The data structure 1102 also includes role definitions 1114 defined for the “transport” leg business entity type 1100. The “role definitions” 1114 include role Organizer 1116 and role Carrier 1118.

The “transport leg” business entity type 1100 includes an internal process 1120, which includes a “reserve” internal process stage 1122, a “start” internal process stage 1124, and an “arrive” internal business process stage 1126. The “transport leg” business entity type 1100 also includes a set of synchronization points 1128 and 1130. The “transport leg” business entity type 1100 can be instantiated to create “transport leg” child collaborative business entities corresponding to the “transport leg 1”, the “transport leg 2”, the “transport leg 3”, and the “transport leg 4”.

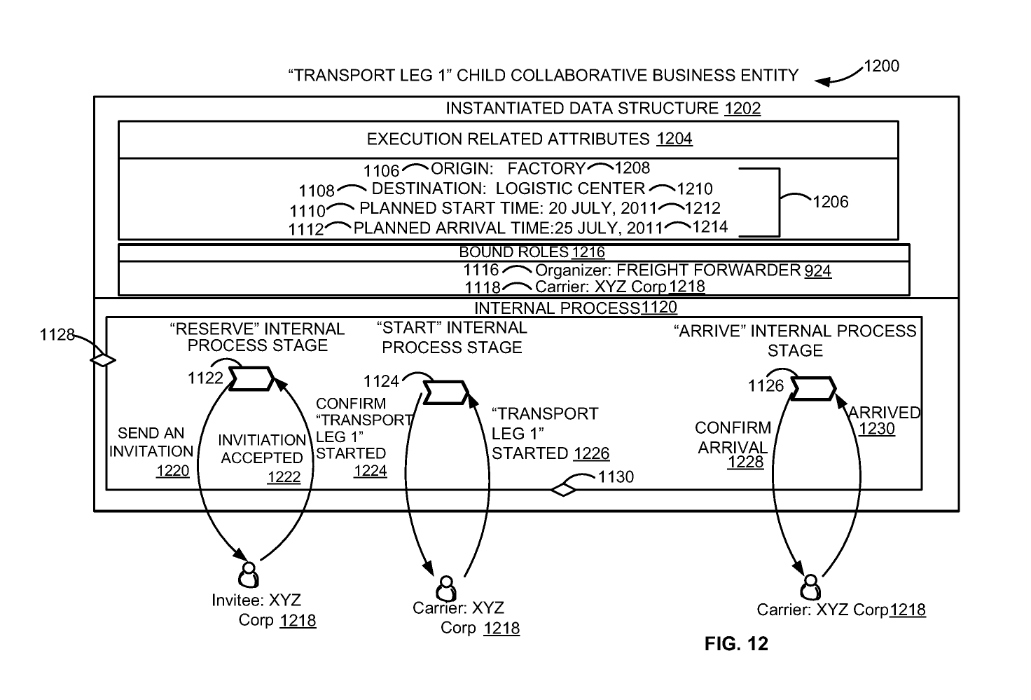

FIG. 12 is a block diagram illustrating a “transport leg 1” child collaborative business entity 1200 created by instantiating the transport leg business entity type 1100 of FIG. 11, according to an embodiment. The “transport leg 1” child collaborative business entity 1200 is created to execute the “transport leg 1” of the “transport” collaborative business process. The “transport leg 1” child collaborative business entity 1200 is created by instantiating the business entity type 1100. As shown, the “transport leg 1” child collaborative business entity 1200 includes an instantiated data structure 1202 which is an instance of the data structure 1102 of the “transport leg” business entity type 1100. The instantiated data structure 1202 includes execution related attributes 1204 created by initializing the execution related attributes 1104 of the “transport leg” business entity type 1100 with execution related data 1206 of the “transport leg 1”. The execution related data of “transport leg 1” 1206 may include: origin of the “transport leg 1”, i.e., “Factory” 1208, destination of the “transport leg 1”, i.e., “Logistic Center” 1210, the planned start time for starting “transport leg 1” (from “Factory”), i.e., “20 Jul., 2011” 1212, and the planned arrival time of “transport leg 1” (at “Logistic Center”), i.e., “25 Jul., 2011” 1214. The execution related attributes 1204 is created by initializing the execution related attributes 1104 with the execution related data 1206. Similarly, child collaborative business entities are created for the “transport leg 2”, the “transport leg 3”, and the “transport leg 4” by initializing the execution related attributes 1106, 1108, 1110, and 1112 of the “transport leg” business entity type 1100 (FIG. 11) with execution related data corresponding to the “transport leg 2”, the “transport leg 3”, and the “transport leg 4”, respectively. The instantiated data structure 1202 also includes bound roles 1216 created by binding the role definition Organizer 1116 and Carrier 1118, defined in the “transport” leg business entity type 1100 with “freight forwarder” 924 and “XYZ Corp” 1218, respectively.

Further, the “transport leg 1” child collaborative business entity 1200 includes the internal process 1120 of the “transport leg” business entity type 1100. During execution of the “transport leg 1” child collaborative business entity 1200, initially the “reserve” internal process stage 1122 is executed. In one embodiment, the “Role Fulfillment” collaborative business entity is executed for sending the invitation 1220 to an invitee XYZ Corp 1218 to play the carrier role. In this case, the inviter is the freight forwarder 924 and the invitee is the carrier XYZ Corp. 1218 who overtakes the responsibility of handling the “transport leg 1” child collaborative business entity. XYZ Corp. 1218 can accept or reject the invitation 1220. In case XYZ Corp. 1218 accepts the invitation 1220 a response “invitation accepted” 1222 is sent to the collaboration hub. Similarly, for the “transport leg 2” child collaborative business the “transport leg 3” child collaborative business entity, and the “transport leg 4” child collaborative business entity the invitation is sent to ABC Corp., “shipcars” New England Logistics”, to play the carrier roles in these respective legs.

After the response “invitation accepted” 1222 is received, the “start” internal process stage 1124 is executed. When the “start” internal process stage 1124 is executed an action item 1224 is sent to XYZ Corp. 1218 that plays the carrier role 1118 to confirm whether the movement of goods for “transport leg 1” has started. In case the movement of goods for “transport leg 1” has started, XYZ Corp. 1218 sends a response 1226 that the movement of goods for “transport leg 1” has started.

Finally after the response “transport leg 1 started” 1226 is received at the collaboration hub, the collaboration hub executes the “arrive” internal process stage 1126. When the “arrive” internal process stage 1126 is executed the action item 1228 is sent to XYZ Corp. 1218 to confirm arrival of the three cars of “type A” at the logistic center. In response to the action item 1228, XYZ Corp. 1218 can provide a response 1230 that the three cars of “type A” have arrived at the “logistic center” (destination) when the three cars of “type A” reach the “logistic center”. The “transport leg 1” child collaborative business entity 1200 also includes “synchronization points” 1128 and 1130 defined in the “transport leg” business entity type 1100. Similarly, the “transport leg 2” child collaborative business entity, the “transport leg 3” child collaborative business entity, and the “transport leg 3” child collaborative business entity also include these synchronization points.

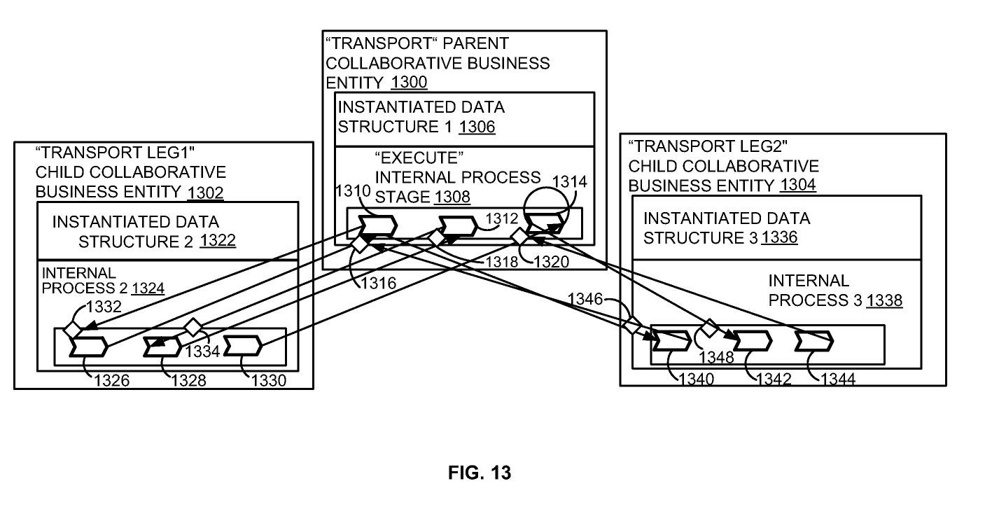

FIG. 13 is a block diagram illustrating synchronization between a “transport” parent collaborative business entity 1300, and a “transport leg 1” child collaborative business entity 1 1302 and a “transport leg 2” child collaborative business entity 1304, according to an embodiment. The “transport” parent collaborative business entity includes an instantiated data structure 1 1306 and an “execute” internal process stage 1308. Only one internal process stage 1308 of the “transport” collaborative business entity 1300 has been illustrated in FIG. 13. However, as discussed above in FIG. 9 the “transport” collaborative business entity 1300 may include other internal process stages as well. The “execute” internal process stage 1308 includes a “reserve” internal process sub-stage 1310, a “start” internal process sub-stage 1312, and a “monitor” internal process sub-stage 1314. The “transport” parent collaborative business entity 1300 also includes synchronization points 1316, 1318, and 1320.

The “transport leg 1” child collaborative business entity 1302 includes an instantiated data structure 2 1322 and an internal process 2 1324. The internal process 2 1324 include a “reserve” internal process stage 1326, a “start” internal process stage 1328, and an “arrive” internal process stage 1330. The “transport leg 1” child collaborative business entity 1302 also includes synchronization points 1332 and 1334. The “transport leg 2” child collaborative business entity 1304 includes an instantiated data structure 3 1336 and an internal process 3 1338. The internal process 3 1338 includes a “reserve” internal process stage 1340, a “start” internal process stage 1342, and an “arrive” internal process stage 1344. The “transport leg 2” child collaborative business entity 1304 also includes synchronization points 1346 and 1348.

In the “execute” internal process stage 1308 the “transport” parent collaborative business entity 1300 coordinates the internal process 2 1324 and the internal process 3 1338 of the “transport leg 1” child collaborative business entity 1302 and the “transport leg 2” child collaborative business entity 1304, respectively. In one embodiment, the “reserve” internal process sub-stage 1310 of the “transport” parent collaborative business entity 1300 uses synchronization points 1332 and 1346 of the “transport leg 1” child collaborative business entity 1302 and the “transport leg 2” child collaborative business entity 1304 to enable these child collaborative business entities (1332 and 1346) to start reservation, i.e., execute “reserve” internal process stage 1326 and “reserve” internal process stage 1340, respectively. After the “reserve” internal process sub-stage 1326 and the “reserve” internal process stage 1340 has been executed, the “transport leg 1” child collaborative business entity 1302 and the “transport leg 2” child collaborative business entity 1304, respectively, respond to the “transport” parent collaborative business entity 1300 using synchronization point 1316 of the “transport” parent collaborative business entity 1300 indicating that the reservation of the child collaborative business entities (1302 and 1304) has been done.

After the “transport leg 1” child collaborative business entity 1302 and the “transport leg 2” child collaborative business entity 1304 have completed their reservation, as indicated using the synchronization point 1316, the “start” internal process sub-stage 1312 of the “transport” parent collaborative business entity 1300 is executed in order to start the “transport” collaborative business process. When the “start” internal process sub-stage 1318 is executed, using synchronization point 1334 the “transport” parent collaborative business entity 1300 enables the “start” internal process stage 1328 of the “transport leg 1” child collaborative business entity 1302. This allows the “transport leg 1” child collaborative business entity 1302 to start the movements of goods for “transport leg 1” of the “transport” collaborative business entity. As the “transport leg 1” is the first leg of the “transport” collaborative business process, this also starts the “transport” (movement of goods) as a whole. If the “transport leg 1” child collaborative business entity 1302 has started, i.e., the “start” internal process stage 1328 has been executed, the “transport leg 1” child collaborative business entity 1302 sends a message to the “transport” parent collaborative business entity using synchronization point 1318.

After receiving the message that the “transport leg 1” has started the “monitor” internal process sub-stage 1314 of the “transport” parent collaborative business entity 1300 is executed. In the “monitor” internal process stage 1314 the “transport” parent collaborative business entity 1300 waits for a message on synchronization point 1320 indicating the arrival of any of the transport legs. For example the “arrive” internal process stage 1330 of the “transport leg 1” child collaborative business entity 1302 has been executed. After receiving the message that “transport leg 1” child collaborative business entity 1302 has arrived the “monitor” internal process sub-stage 1314 enables the next child, in this case the “transport leg 2” child collaborative business entity 1304 to start its transport. The “transport” parent collaborative business entity 1300 does this using synchronization point 1348 which enables the “start” internal process stage 1342 of the “transport leg 2” child collaborative business entity 1304. Next, the “monitor” sub-stage 1314 of the “transport” parent collaborative business entity 1300 goes in a loop and subsequently waits on the synchronization point 1320 for the message from the “transport leg 2” child collaborative business entity 1304 that it has arrived, i.e., the “arrive” internal process stage 1344 has been executed. A person skilled in the art can understand that similarly any number of “transport leg” child collaborative business entities can be synchronized.

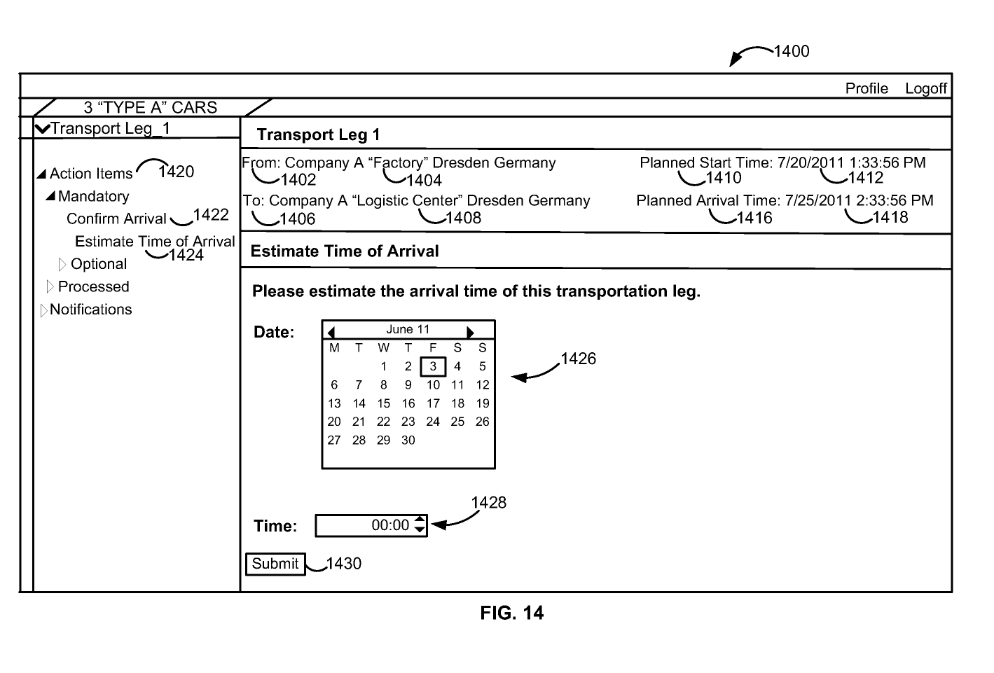

FIG. 14 is a block diagram illustrating a screenshot of a portal 1400 for the “transport leg 1” child collaborative business entity, according to an embodiment. In one embodiment, the screenshot 1400 is displayed to the carrier (ABC Corp.) of the “transport leg 1”. The screenshot displays the execution related data for the “transport leg 1” such as the origin, “From” 1402, of the “transport leg 1” child collaborative business entity which is the “Factory” 1404 of company A at Dresden, Germany, the destination, “To” 1406, of the “transport leg 1” child collaborative business entity which is the “logistic center” 1408 of Company A in Dresden, Germany, the “planned start time” 1410 for the start of the “transport leg 1” child collaborative business entity which is Jul. 20, 2011 at 1:33:56 PM 1412, the “planned arrival time” 1416 for the “transport leg 1” child collaborative business entity which is 25 Jul., 2011 at 2:33:56 PM 1418.

A set of action items 1420 related to the “transport leg 1” child collaborative business entity are provided to the carrier (ABC Corp.). As shown, the action items 1420 include a “Confirm Arrival” 1422 which the carrier (ABC CORP.) can select after the three cars of “type A” reaches the Logistic Center in Dresden, Germany. The action item 1420 also includes the “estimated time of arrival” 1424 to provide the expected time of arrival (ETA) of the three cars of type A at the Logistic Center in Dresden, Germany. A calendar 1426 and time 1428 is provided to the carrier (ABC Corp) for selecting the estimated time and date for the arrival of the three cars of “type A” at the factory in Dresden, Germany. After selecting the estimated date and time of arrival the carrier “ABC Corp.” selects “Submit” 1430 to submit the estimated date and time to the portal.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls or web services being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

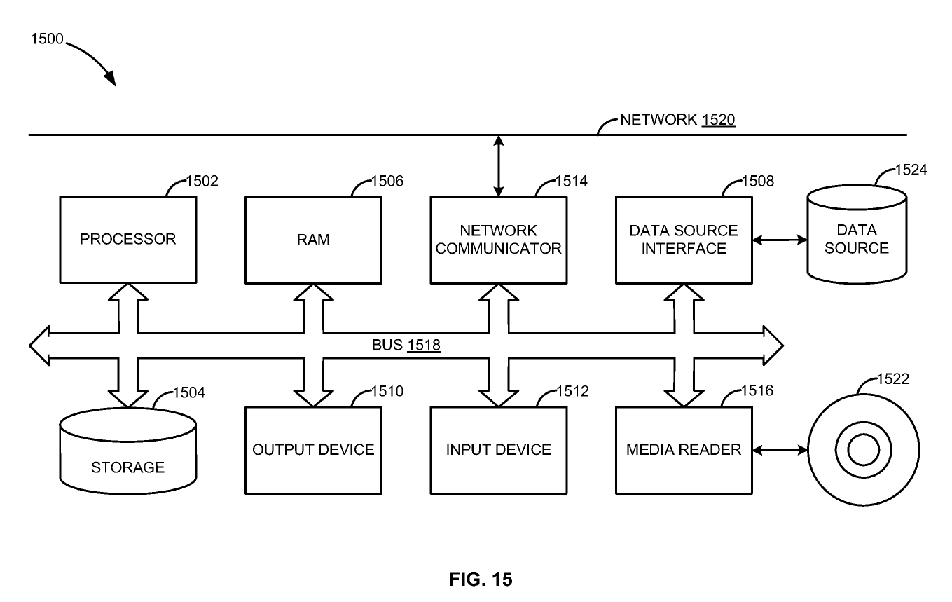

FIG. 15 is a block diagram of an exemplary computer system 1500. The computer system 1500 includes a processor 1502 that executes software instructions or code stored on a computer readable storage medium 1522 to perform the above-illustrated methods of the invention. The computer system 1500 includes a media reader 1516 to read the instructions from the computer readable storage medium 1522 and store the instructions in storage 1504 or in random access memory (RAM) 1506. The storage 1504 provides a large space for keeping static data where at least some instructions could be stored for later execution. The stored instructions may be further compiled to generate other representations of the instructions and dynamically stored in the RAM 1506. The processor 1502 reads instructions from the RAM 1506 and performs actions as instructed. According to one embodiment of the invention, the computer system 1500 further includes an output device 1510 (e.g., a display) to provide at least some of the results of the execution as output including, but not limited to, visual information to users and an input device 1512 to provide a user or another device with means for entering data and/or otherwise interact with the computer system 1500. Each of these output devices 1510 and input devices 1512 could be joined by one or more additional peripherals to further expand the capabilities of the computer system 1500. A network communicator 1514 may be provided to connect the computer system 1500 to a network 1520 and in turn to other devices connected to the network 1520 including other clients, servers, data stores, and interfaces, for instance. The modules of the computer system 1500 are interconnected via a bus 1518. Computer system 1500 includes a data source interface 1508 to access data source 1524. The data source 1524 can be accessed via one or more abstraction layers implemented in hardware or software. For example, the data source 1524 may be accessed by network 1520. In some embodiments the data source 1524 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer implemented method for coordinating execution of a collaborative business process, the method comprising:
executing a first internal process stage included in a parent collaborative business entity on a collaboration hub;
based on the execution, receiving a process plan for the collaborative business process;
based on the received process plan, the collaboration hub instantiating a business entity type to create one or more child collaborative business entities, wherein the business entity type includes a predefined internal process and a pre-defined data structure; and
executing the predefined internal process included in the created one or more child collaborative business entities to coordinate execution of the collaborative business process.

2. The computer implemented method according to claim 1, wherein executing the first internal process stage comprises:
the collaboration hub sending a request for creating the process plan for the collaborative business process to a business partner; and
the collaboration hub receiving the created process plan from the business partner.

3. The computer implemented method according to claim 1, further comprising:
the collaboration hub sending an action item to create the one or more child collaborative business entities; and
the collaboration hub receiving the created one or more child collaborative business entities.

4. The computer implemented method according to claim 1, wherein creating the one or more child collaborative business entities comprises:
based on the received process plan, executing a second internal process stage included in the parent collaborative business entity to create the one or more child collaborative business entities.

5. The computer implemented method according to claim 1, wherein executing the predefined internal process in the created one or more child collaborative business entities comprises:
executing a first internal process stage included in the predefined internal process to send an action item to a business partner;
receiving a response for the action item from the business partner; and
based on the received response, executing a second internal process stage included in the predefined internal process.

6. The computer implemented method according to claim 1, further comprising:
synchronizing execution of an internal process stage of the created one or more child collaborative business entities, wherein a third internal process stage of the parent collaborative business entity synchronizes execution of the internal process stage of the one or more child collaborative business entities using one or more synchronization points.

7. The computer implemented method according to claim 1, wherein creating the one or more child collaborative business entities comprises:
storing execution related data in the created one or more child collaborative business entities, wherein storing the execution related data includes initializing a set of execution related attributes included in the data structure with the execution related data and binding one or more business partner roles.

8. The computer implemented method according to claim 1, further comprising:
based on a collaborative business entity status stored in the created one or more child collaborative business entities, the collaboration hub sending a notification to one or more business partners.

9. An article of manufacture including a computer readable storage medium to tangibly store instructions, which when executed by a computer, cause the computer to:
execute a first internal process stage included in a parent collaborative business entity;
based on the execution, receive a process plan for a collaborative business process;
based on the received process plan, instantiate a business entity type to create one or more child collaborative business entities, wherein the business entity type includes a predefined internal process and a predefined data structure; and
execute the predefined internal process included in the created one or more child collaborative business entities to coordinate execution of the collaborative business process.

10. The article of manufacture according to claim 9, further comprising instructions which when executed by the computer further causes the computer to:
send a request to create the process plan for the collaborative business process to a business partner; and
receive the created process plan from the business partner.

11. The article of manufacture according to claim 9, further comprising instructions which when executed by the computer further causes the computer to:
send a request to create the one or more child collaborative business entities; and
receive the created one or more child collaborative business entities.

12. The article of manufacture according to claim 9, wherein executing the predefined internal process included in the created one or more child collaborative business entities comprises:
execute a first internal process stage included in the predefined internal process to send an action item to a business partner;
receive a response for the action item from the business partner; and
based on the received response, execute a second internal process stage included in the predefined internal process.

13. The article of manufacture according to claim 9, further comprising instructions which when executed by the computer further causes the computer to:
synchronize execution of an internal process stage of the created one or more child collaborative business entities, wherein a third internal process stage of the parent collaborative business entity synchronizes execution of the internal process stage of the one or more child collaborative business entities using one or more synchronization points.

14. The article of manufacture according to claim 9, wherein execution related data received in the process plan is stored in the created one or more child collaborative business entities, and wherein the execution related data initializes a set of execution related attributes included in the predefined business data structure and bind one or more business rules.

15. A computer system for coordinating execution of a collaborative business process, the computer system comprising:
a memory to store a program code; and
a processor communicatively coupled to the memory, the processor configured to execute the program code to:
execute a first internal process stage included in a parent collaborative business entity;
based on the execution, receive a process plan for the collaborative business process;
based on the received process plan, instantiate a business entity type to create one or more child collaborative business entities, wherein the business entity type includes a predefined internal process and a predefined data structure; and
execute the predefined internal process in the created one or more child collaborative business entities to coordinate execution of the collaborative business process.

16. The system of claim 15, wherein the processor further executes the program code to:
send a request to create the process plan for the collaborative business process to a business partner; and
receive the created process plan from the business partner.

17. The system of claim 15, wherein the processor further executes the program code to:
send a request to create the one or more child collaborative business entities; and
receive the created one or more child collaborative business entities.

18. The system of claim 15, wherein the processor further executes the program code to:
execute a first internal process stage included in the internal process to send an action item to a business partner;
receive a response for the action item from the business partner; and
based on the received response, execute a second internal process stage included in the internal process.

19. The system of claim 15, wherein the processor further executes the program code to:
synchronize execution of an internal process stage of the created one or more child collaborative business entities, wherein a third internal process stage of the parent collaborative business entity synchronizes execution of the internal process stage of the one or more child collaborative business entities using one or more synchronization points.

20. The system of claim 15, wherein an execution related data received in the process plan is stored in the created one or more child collaborative business entities, and wherein the execution related data initializes a set of execution related attributes included in the predefined data structure and bind one or more business roles.
